(19) United States
(12) Patent Application Publication
(10) Pub. No.: US 2005/0172170 A1
(43) Pub. Date: Aug. 4, 2005

(54) Application of live machine data to customer support fault isolation processes

(75) Inventors: Tracy E. Thieret, Webster, NY (US); Samuel A. Fedele, Victor, NY (US)

Correspondence Address: Ortiz & Lopez, PLLC, P.O. Box 4484, Albuquerque, NM, 87196-4484, US

(73) Assignee: Xerox Corporation

(21) Appl. No.: 10/759,682

(22) Filed: Jan. 16, 2004

(51) Int. Cl. G06F 11/00

(52) U.S. Cl. 714/37

(57) ABSTRACT

Methods and systems where remotely accessible machine-provided data is provided to a customer support (e.g., “help desk”) enterprise system wherein the data automatically satisfies a need for most information traditionally provided for analysis manually during a conversation. Advanced data enables help desk personnel to expeditiously interact with customers and gather specific data useful for isolating a problem and correcting it. Data can convey information regarding a machine's model type, location, serial number, usage history (e.g., counter data), fault codes, etc. Data can be provided directly by the machine over networks to customer support facilities.

### FIELD OF THE INVENTION

The present invention is generally related to automated customer assistance. More particularly, the present invention is related to methods and system providing live machine data to customer support enterprises to enable fault isolation and resolution processes.

### BACKGROUND

Equipment trouble resolution centers such as helps desks, welcome centers, customer support and the like, are available to assist customers with resolving equipment failure or operational problems. Specialized customer support representatives can identify and resolve problems, or can otherwise schedule repairs and maintenance.

Currently, manufacturing companies and other commercial enterprises rely solely on a conversation with the customer as the first level of support for fixing problems that can occur with products. Conversations can be costly, sometimes amounting to about $4 per call and $1 per minute, with large enterprises logging more than 100,000 minutes of customer service calls per month. Conversations between customers and the servicing enterprise can often be time consuming and costly for the customer or enterprise, depending on whom the paying party is. Large enterprises can experience hundreds of thousands of minutes of communications charges to provide a customer helpline.

In addition to being costly, “help-desk” calls can be annoying for customers because much time is spent gathering preliminary information about a product before the essence of the problem is addressed. Information like the customer's name, the machine serial number, and questions like “what were you doing at the time of the failure,” and what information is displayed on the User Interface,” are the content of these questions. A troubleshooting conversation can be particularly annoying to customers lacking time or in-depth knowledge of their equipment's operation and physical attributes. After “preliminaries”, the customer must navigate with the representative through a fault isolation tree (e.g., troubleshooting processes) in order to identify the potential problem. Also, many customers lack a useful understanding of how complex equipment operates or with identifying malfunctions. It is particularly difficult because frequently customers do not have a vocabulary to describe the problem or what the User Interface is displaying.

The other extremum in help desk applications is an application that permits the help desk personnel to “take control” of your PC or laptop. Dell, IBM and others preload laptops with this application and expect that when you are asked by the help desk person for access that you'll grant it. The problem with this mode is that the person or application taking control of your PC has access to ALL your files and data and also access to the local network resources—PCs and servers—with the authentication of the PC's owner. The transactions performed during this “diagnostic session” happen “in the dark” in a “trust me” environment. The present invention provides the help desk with the information they need in an auditable way without compromising the security of the enterprise.

Help-desk-associated conversations will often consist of a series of questions asked of the customer by help-desk personnel. The question sequence asked by the help-desk personnel is generally associated with programmed responses from case-based software that may be utilized to navigate the representative and customer through a fault isolation tree. The customer is oftentimes asked to carry out corrective steps during the troubleshooting process. The customer support process oftentimes does not produce satisfactory results.

The present inventors recognize the potential for solutions that will reduce costs and frustration experienced with current help-desk processes and facilities. The inventors seek to eliminate or reduce the duration of calls experienced by most enterprise help-desk facilities.

### SUMMARY OF THE INVENTION

Methods and systems enabling enterprise help-desk facilities to reduce costs and frustration associated with current fault isolation (e.g., troubleshooting) processes are described.

In accordance with features of the present invention, customer and representative conversations are augmented with electronic troubleshooting data obtained remotely from a troubled system (e.g., a malfunctioning photocopying machine but could be much more general than that). Troubleshooting data can include machine identification, location, diagnostics and operational state data. In addition, the machine identification can be used by the Help Desk to determine the customer's contractual entitlements to help desk and other assistance (i.e. is the customer on a maintenance agreement?).

In accordance with another feature of the present invention, the troubleshooting data can be constructed as a human-readable (for auditing purposes) file by the machine and the file can be provided to help-desk facilities.

In accordance with other feature of the present invention, the data can be provided directly from the machine over a network or as an electronic file through a computer network by the customer/user.

Advanced troubleshooting data can substantially shorten the duration of a conversation between help-desk personnel and the customer, translating into savings. It avoids asking the customer questions that the machine can answer. In addition, the machine provides the information directly, eliminating transcription errors. Finally, the customer need not be embarrassed by not understanding the vocabulary of diagnostics of printer failures.

In accordance with a method of the present invention, troubleshooting information associated with a machine can be coordinated with remote support enterprises by maintaining troubleshooting-related information associated with functions of the machine within a database associated with the machine and providing troubleshooting-related information over a data network to a remote support enterprise for fault analysis and utilization during customer interaction. The troubleshooting-related information can include at least one of: machine identity, machine location, error codes, machine usage history and customer identification.

Troubleshooting information can be formatted in an appropriate data transport language (e.g., XML is currently available and can be used) prior to it being provided over the data network to the remote support enterprise. The troubleshooting information, once received by a remote support enterprise over the data network, can automatically process the information and the enterprise can provide communication with a customer associated with the machine. Corrective data can be developed by the remote support enterprise. The corrective data can be transmitted over the data network where after it is received by the machine. The corrective data is automatically processed by the machine and the database of troubleshooting-related information associated with ongoing functions of the machine is maintained.

In accordance with a system for the present invention a customer support enterprise receives over a data network troubleshooting data from a remote malfunctioning machine, said troubleshooting data needed for analysis and providing correcting malfunctions of a machine within a support enterprise.

The customer support enterprise automatically processing the troubleshooting data by enterprise equipment at the customer support enterprise. After analysis, the customer support enterprise can proceed with at least one of:
i) telephonically interacting with a customer using the troubleshooting data provided by the remote malfunctioning machine as a basis for the customer interaction, and providing the customer with corrective action based on troubleshooting data provided by the remote malfunctioning machine and the customer interaction;
ii) providing corrective action over the data network directly to the remote malfunctioning machine after automatic analysis of the troubleshooting data; and
iii) escalating customer support to advanced support and providing advanced support utilizing at least one of the troubleshooting data, the analysis of the troubleshooting data, and customer interaction.

### DRAWINGS

FIG. 1 illustrates a networked customer support system in accordance with features the present invention;

FIG. 2 illustrates a machine enabled with troubleshooting data management and reporting processes in accordance with features of the present invention;

FIG. 3 illustrates an enterprise customer support system adapted for use of features in accordance with the present invention;

FIG. 4 illustrates a flow diagram of method steps in accordance with features of the present invention;

FIG. 5 illustrates a flow diagram of method steps in accordance with features of the present invention; and

FIG. 6 illustrates a flow diagram of method steps in accordance with features of the present invention.

### DETAIL DESCRIPTION OF THE PREFERRED EMBODIMENTS

Machine-provided troubleshooting data augments a fault isolation tree's solution capabilities and increases its precision. With broad adoption of the present invention, calls might someday be eliminated where the customer can interact with a web-based analysis system having the benefit of troubleshooting data provided directly from the faulty equipment. Regardless of how the data are processed, a more detailed and accurate representation of the situation would be available when machine provided troubleshooting data is available than where the information must be obtained from a customer.

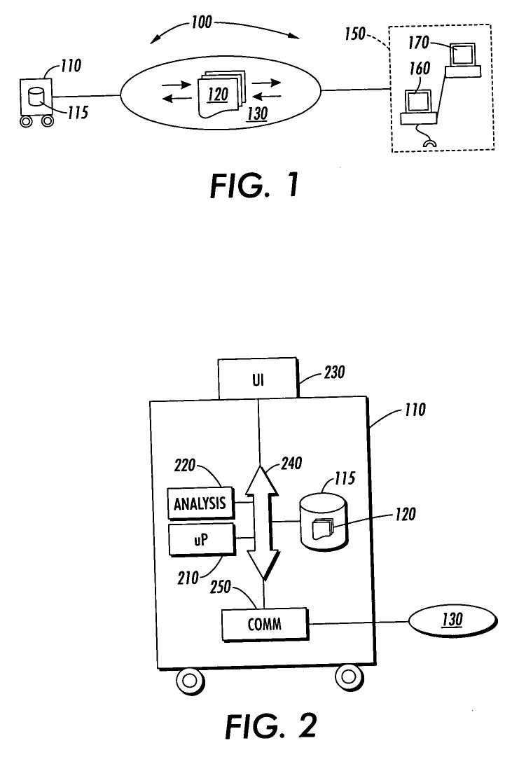

Referring to FIG. 1, a networked system 100 in accordance with features the present invention is illustrated. A machine 110 will hopefully operate normally and for reasonable periods of time between repairs or maintenance. When a machine does malfunction, data is collected in a database 115 for use in subsequent troubleshooting (e.g., “troubleshooting data”) using software and machine based sensors (not shown) with which the machine is normally equipped. Troubleshooting data 120 can include machine identity, location, error codes, usage history, and other important data that can be useful to those skilled in the art of repairing the specific machine 110. Once an error is experienced, an electronic document 120 containing the troubleshooting data can be transmitted over a data network 130 to a remote enterprise 150 assigned to provide support for the machine and to customers. The enterprise will typically include a help desk 160 with personnel experienced in providing maintenance and troubleshooting advice for the particular type machine. If more specific, skilled assistance is ever required, the data can be escalated to another representative 170.

In accordance with features of the present invention, the document 120 can be provided to the enterprise 150 in advance of, or concurrently with, a customer telephonically communicating with the support enterprise 150. The present invention can provide the enterprise and customer with the benefit of detailed data and pre-conversation analysis, thereby reducing the time and costs associated with the service support session. When engaged in communication with first level support 160, both the customer and the data can be elevated to other personnel 170 within the enterprise 150.

Referring to FIG. 2, a block diagram of machine 115 incorporating features of the present invention is illustrated. Machines 110 such as modern office and industrial equipment are often equipment with a microprocessor 210 and data communications 250. The devices under consideration (Photocopiers and networked printers, for example—but not limited to these), include a microprocessor 210, data network communication hardware 250 (e.g., Ethernet), an analysis module 220, a user interface 230 and an internal communication bus 240. In accordance with a unique feature of the present invention, a database is provided 115 that is adapted to develop a document 120 containing data useful for troubleshooting the machine 110. The document 120 is developed with input and assistance of the previously identified elements that are organic to the machine 110. The document 120 can be transmitted over a data network 130 using the communication equipment 250.

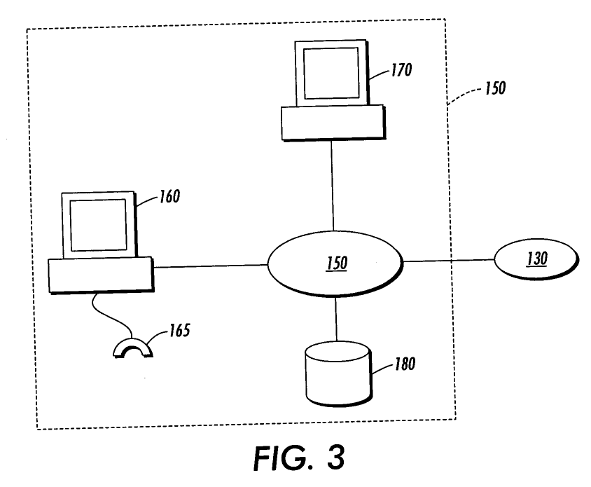

Referring to FIG. 3, Illustrates a block diagram of a customer support enterprise 150. A typical customer support enterprise includes first level support agents 160 and more specialized assistance 170 to which a customer's call may be escalated. The enterprise 150 will typically have an internal network 150 including call center technology used for routing calls and transporting data. The enterprise is provided with data and voice communications via network 130. An enterprise 150 incorporating features of the present invention will include a database 180 adapted for managing troubleshooting data contained in documents 120 provided to the enterprise via network 130 from remote equipment 110. IT should be appreciated based on the present description that computational methods can take the document from the network 130 and process it and the information previously collected together with information about other devices of the same type to automatically to provide assistance and suggestions using suitable troubleshooting software. The previous information from the device in question, the current information about the same device, and the information about the population of similar devices available to the customer support enterprise can be used together to provide an improved assessment of remediation options that address the trouble the device is having.

The document 130 has information on the device after it has failed. The previous data from the device has information on the device prior to failure and may be processed to provide leading indicators of failure. The information about the population of devices may be processed to extract information as to how other devices of the same or similar classes behave under similar conditions (that is, other devices may have had similar symptoms, those symptoms were indicative of a particular problem). With advanced information a device can send a document 130 leading to an immediate suggestion of what to do in this particular case.

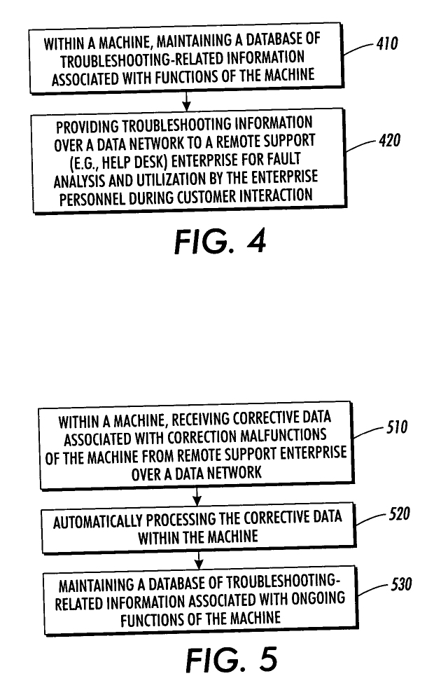

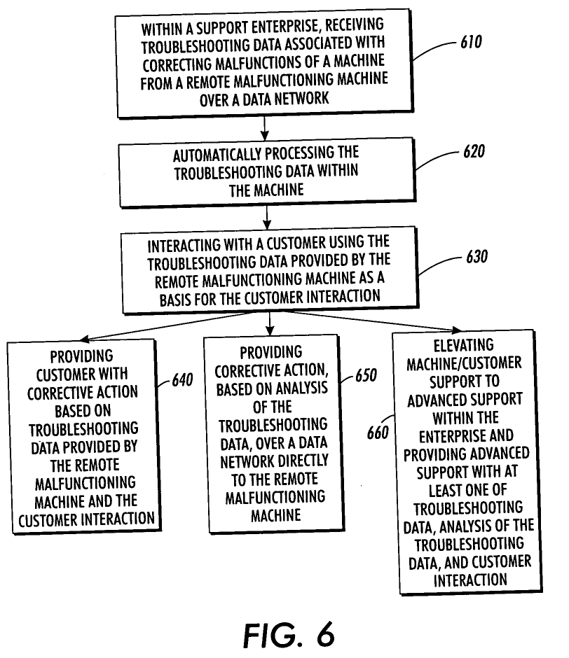

Referring to FIG. 4, flow diagram 400 illustrating steps in accordance with a feature of the present invention is illustrated. As shown in step 410, a database of troubleshooting-related information associated with functions of the machine is maintained within the machine. As shown in step 420, troubleshooting information is provided over a data network to a remote support (e.g., help desk) enterprise for fault analysis and utilization by the enterprise personal during customer interaction.

Referring to FIG. 5, a flow diagram 500 illustrates steps in accordance with additional features of the present invention. As shown in step 510, corrective data is received from remote support enterprise over a data network with a machine that is associated with correcting malfunctions of the machine. As shown in step 520, the corrective data is automatically processed within the machine. As shown in step 530, a database of troubleshooting-related information associated with ongoing functions of the machine is maintained.

Referring to FIG. 5, flow diagram 600 illustrates steps in accordance with a feature of the present invention is illustrated. As shown in step 610, troubleshooting data associated with correcting malfunctions of a machine from a remote malfunctioning machine are received over a data network within a support enterprise. In step 620, the troubleshooting data is automatically processed within the machine. In step 630, a customer support enterprise interacts with a customer using the troubleshooting data provided by the remote malfunctioning machine as a basis for the customer interaction. As shown in step 630, once interaction is completed, the process can proceed into at least three different paths. As shown in step 640, a customer is provided with corrective action based on troubleshooting data provided by the remote malfunctioning machine and the customer interaction. As shown in step 650, corrective action is provided over a data network directly to the remote malfunctioning machine—action that is based on analysis of the troubleshooting data. In step 660, shown is a step of escalating machine/customer support to advanced support within the enterprise and providing advanced support with at least one of troubleshooting data, analysis of the troubleshooting data, and customer interaction.

As an example of such a systems operation, suppose that a photocopier provided a file of labeled data containing a set of information about its identification, location, configuration and current state. This is currently possible with high-end photocopiers having network connectivity. I can be appreciated that photocopiers and networked printers together with other networked devices (e.g. refrigerators, HVAC equipment, and the like) can benefit from the present invention as home networks become more common. The present invention may be applied to any device with the internal structure indicated in FIG. 1. The idea is to make servicing these devices easier using bi-directional connectivity.

A network connection can also be used to inform customers about how certain features for a device can be accessed (about 40-50% of help desk calls are from customers who know that their device can do something but don't know how to access and use the feature). Through the network, the machine can be queried and prompted to provide data useful for troubleshooting. A remote help desk enterprise application can request and receive data directly from the device. Alternatively, a malfunctioning machine can be programmed to automatically provide a data file to a designated help center where the data can be assessed prior to customer communication.

During automated processing, the help desk enterprise can perform a check of the labeled machine data file before formulating questions to be asked of customers. The troubleshooting process can take a form similar of nodes in a graph (like a flowchart or a tree structure but with cross branch connections), wherein each node represents a query, or series of queries. Each node would check the data file for the presence of a particular labeled data or object element. If a label is identified, the data associated with the label would be used as the answer to the question or the object's method (software code) or internal software code would be executed by the device to obtain the answer. The machine would then have answered the question and asking the question of the customer would be unnecessary.

There are a host of available mechanisms for labeling the machine data; however, the preferred embodiment currently in use is the extensible Markup Language (XML). XML is an object description language. It should be appreciated that other industry standard or proprietary object description language can be used. Any reference to “object description interface” used herein should be interpreted to also refer to “XML” and any future “object description interface” equivalents that may be used to carry out the methods of the present invention. (“Object”—as in “Object Oriented Programming” refers to an entity that can contain data or executable code or both.) The corrective action taken by the object description interface will preferably include adjusting data values in the device or supplying supplementary code either to fix the problem or to provide additional diagnostic capability to the device for determining the problem as in complex or intermittent failures. (I know this isn't “claim language” but I wanted to get the idea across) XML provides for a definition of allowed parameters, data communication between enabled devices, and labeling using tags. XML is rapidly being adopted and in place of HTTP because HTTP provides only layout definition rather than content identification. Thus, machines are provided with increased data sharing capacity. It should be appreciated that, where a machine does not yet provide certain data, the customer can be prompted to provide answers in the normal process of help-desk troubleshooting.

It should be appreciated that, should action be required of a particular case that a help desk can not address, the data and any associated call information can both be escalated within the enterprise to more specific assistance. The call and/or data can also be directed to parts ordering facilities, advanced systems support and warranty specialists. Furthermore, because of network communications between the machine and enterprise providing help, corrective measures can be provided directly to the machine from the enterprise. For example, software patches and updates can be installed remotely using data communications.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. Coordinating troubleshooting information associated with a machine, comprising the steps of:
maintaining troubleshooting-related information associated with functions of the machine within a database associated with the machine; and
providing troubleshooting-related information over a data network to a remote support enterprise for fault analysis and utilization during customer interaction.

2. The method of claim 1 wherein the troubleshooting-related information includes at least one of: machine identity, machine location, error codes, machine usage history and customer identification.

3. The method of claim 1 wherein the troubleshooting information is formatted in an object description interface prior to it being provided over the data network to the remote support enterprise.

4. The method of claim 1 further comprising the steps wherein:
the troubleshooting-related information is received by a remote support enterprise over the data network; and
the troubleshooting-related information is automatically processed by the remote support enterprise.

5. The method of claim 1 further comprising the steps wherein:
the troubleshooting-related information is received by a remote support enterprise over the data network;
the troubleshooting-related information is automatically processed by the remote support enterprise;
communication is provided by the remote support enterprise with a customer associated with the machine; and
corrective data is developed by the remote support enterprise.

6. The method of claim 1 further comprising the steps wherein:
corrective data is received by the machine from the remote support enterprise over the data network;
the corrective data is automatically processed by the machine; and
the database of troubleshooting-related information associated with ongoing functions of the machine is maintained.

7. The method of claim 4 further comprising the steps wherein:
corrective data is received by the machine from the remote support enterprise over the data network;
the corrective data is automatically processed by the machine; and
the database of troubleshooting-related information associated with ongoing functions of the machine is maintained.

8. The method of claim 5 further comprising the steps wherein:
corrective data is received by the machine from the remote support enterprise over the data network;
the corrective data is automatically processed by the machine; and
the database of troubleshooting-related information associated with ongoing functions of the machine is maintained.

9. The method of claim 4 wherein the troubleshooting-related information includes at least one of: machine identity, machine location, error codes, machine usage history and customer identification.

10. The method of claim 4 wherein the troubleshooting information is formatted in XML prior to it being provided over the data network to the remote support enterprise.

11. The method of claim 5 wherein the troubleshooting-related information includes at least one of: machine identity, machine location, error codes, machine usage history and customer identification.

12. The method of claim 5 wherein the troubleshooting information is formatted in XML prior to it being provided over the data network to the remote support enterprise.

13. The method of claim 6 wherein the troubleshooting-related information includes at least one of: machine identity, machine location, error codes, machine usage history and customer identification.

14. The method of claim 6 wherein the troubleshooting information is formatted in XML prior to it being provided over the data network to the remote support enterprise.

15. The method of claim 7 wherein the troubleshooting-related information includes at least one of: machine identity, machine location, error codes, machine usage history and customer identification.

16. The method of claim 7 wherein the troubleshooting information is formatted in XML prior to it being provided over the data network to the remote support enterprise.

17. Coordinating troubleshooting of a remote machine, comprising the steps of:
a customer support enterprise receiving over a data network troubleshooting data from a remote malfunctioning machine, said troubleshooting data needed for analysis and providing correcting malfunctions of a machine within a support enterprise;
automatically processing the troubleshooting data by enterprise equipment at the customer support enterprise; and
the customer support enterprise proceeding with at least one of:
i) electronically interacting with a customer using the troubleshooting data provided by the remote malfunctioning machine as a basis for the customer interaction, and providing the customer with corrective action based on troubleshooting data provided by the remote malfunctioning machine and the customer interaction;
ii) providing corrective action over the data network directly to the remote malfunctioning machine after automatic analysis of the troubleshooting data; and
iii) escalating customer support to advanced support and providing advanced support utilizing at least one of the troubleshooting data, the analysis of the troubleshooting data, and customer interaction.

18. The method of claim 17 wherein the troubleshooting information is formatted in an object description interface prior to it being provided over the data network to the remote support enterprise.

19. A machine comprising:
a microprocessor;
data communications equipment;
an analysis module;
a database adapted to develop a document containing data useful for remote troubleshooting of the machine;
a user interface; and
wherein a document is developed with input and assistance of the previously identified elements that are organic to the machine, the document formatted for transmission over the data network using the communication equipment.

20. The invention of claim 19, wherein the machine is a photocopier, printer, or other marking device.

21. The invention of claim 19, wherein the machine is a photocopier.

22. The invention of claim 19, wherein the machine is a printer.

23. The invention of claim 19, wherein the devices internal software is adapted causing corrective measures to be automatically executed on the machine in response to data received from a remote enterprise.

24. The invention of claim 19, wherein the device's internal software is adapted causing additional data collection to occur in response to data or software received from the remote enterprise.
